(19) United States
(12) Patent Application Publication
(10) Pub. No.: US 2014/0101528 A1
(43) Pub. Date: Apr. 10, 2014

(54) AUTOMATIC GENERATION OF PORTAL THEMES AND COMPONENTS

(71) Applicants: Tomer Pelleg, Tel Aviv (IL); Nimrod Barak, Tel Aviv (IL)

(72) Inventors: Tomer Pelleg, Tel Aviv (IL); Nimrod Barak, Tel Aviv (IL)

(21) Appl. No.: 13/644,337

(22) Filed: Oct. 4, 2012

(51) Int. Cl. G06F 3/01; G06F 17/00

(52) U.S. Cl. 715/234

(57) ABSTRACT

The present disclosure involves systems, software, and computer implemented methods for generating code and/or style elements for a web page based on analyzed differences between a UI design and a default UI template. One example method includes identifying a user interface design created for at least one web page, where the UI design comprises a modified version of a default UI template. At least one difference between the identified UI design and the default UI template is analyzed. At least a subset of code and at least one style element are generated for the at least one web page in response to identifying the UI design, the subset of generated code and the at least one generated style element based on the at least one analyzed difference between the identified UI design and the default UI template.

### TECHNICAL FIELD

The present disclosure relates to computer-implemented methods, software, and systems for generating code and/or style elements for a web page based on analyzed differences between a user interface (UI) design and a default UI template.

### BACKGROUND

Enterprise portals are frameworks for integrating information, people, and processes across organizational boundaries. Portals can provide a secure unified access point, often in the form of a web-based user interface, and are designed to aggregate and personalize information through application-specific portlets and components. One hallmark of enterprise portals is the decentralized content contribution and content management, which keeps the information always updated. In many cases, specific portal pages may be defined by a highly experienced administrator using a portal content administration environment or a key user within a particular organization using specific tools to define aspects, relationships, and connections for and between content provided within specific portal pages.

### SUMMARY

The present disclosure involves systems, software, and computer implemented methods for generating code and/or style elements for a web page based on analyzed differences between a UI design and a default UI template. One example method includes identifying a user interface design created for at least one web page, where the UI design comprises a modified version of a default UI template. At least one difference between the identified UI design and the default UI template is analyzed. At least a subset of code and at least one style element are generated for the at least one web page in response to identifying the UI design, the subset of generated code and the at least one generated style element based on the at least one analyzed difference between the identified UI design and the default UI template.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for generating code and/or style elements for a web page based on analyzed differences between a UI design and a default UI template.

FIG. 2A illustrates an example portal page that presents an example default UI template.

FIG. 2B illustrates UI components that can be included in a masthead component included in a default UI template.

FIG. 3 illustrates example portal pages that present an example default UI template on a tablet device and on a mobile device, respectively.

FIG. 4 illustrates a first example of a UI design and corresponding generated web pages.

FIGS. 5A to 5C illustrate a second example UI design and corresponding generated web pages.

FIGS. 6A to 6C illustrate a third example UI design and corresponding generated web pages.

FIGS. 7A to 7C illustrate a UI design for generation of portal pages for presentation to clients via a mobile device or a tablet device and corresponding generated web pages.

FIG. 8 is a flowchart of an example method for generating code and/or style elements for a web page based on analyzed differences between a UI design and a default UI template.

### DETAILED DESCRIPTION

An employee of an organization, such as a corporation, may desire to create a portal site that is accessible to internal employees of the organization and/or to users that are external to the organization. The employee may, for example, desire to create a new portal site that includes one or more applications or that provides one or more documents, or other content. The employee may not be familiar with website or portal site development, may not desire to invest much time in developing the style and branding of the new portal site, and may desire to create the new portal site with little or no involvement from IT (Information Technology) personnel of the organization.

To create a portal site, the employee can create a UI design as a modification of a default UI template, where the default UI template can be provided, for example, by the IT department or a company providing customizable portal solutions. For example, the user can create as a UI design an image which indicates which UI components of the default UI template to include, which UI components to remove, and style information (e.g., colors, fonts, etc.) for included UI components. Suitable image editing software can be used to modify the default UI template, including, for example, Adobe® Photoshop® software, as well as any others. An automatic theme generator component can analyze differences between the UI design created by the employee and the default UI template, and can automatically generate code and style elements for one or more web pages to include in the portal site.

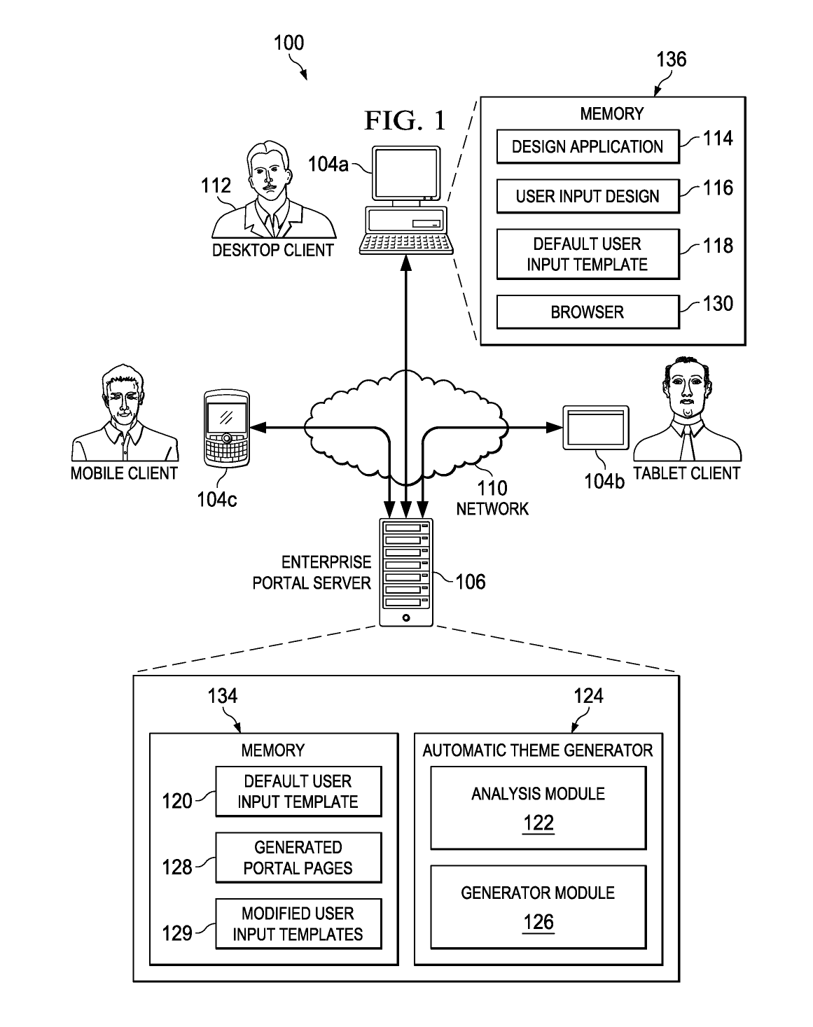

FIG. 1 is a block diagram illustrating an example system 100 for generating code and/or style elements for a web page based on analyzed differences between a UI design and a default UI template. Specifically, the illustrated environment 100 includes or is communicably coupled with a desktop client 104a, a tablet client 104b, a mobile (e.g., smartphone) client 104c, an enterprise portal server 106, and a network 110.

A user 112, such as an employee of an organization, can use a design application 114 executing on the desktop client 104a to create a UI design 116. The UI design 116 can reflect, for example, a design for a new portal page. The UI design 116 can be a modification of a default UI template 118. The default UI template 118 can be received, for example, from the enterprise portal server 106 as a copy of a default UI template 120 stored on the enterprise portal server 106. The default UI template 118 can include, for example, UI components (or representations of UI components) and style information.

The UI design 116 can be or can include, for example, an image. In some implementations, the UI design 116, when first created, is an image of the default UI template 118. The design application 114 can be, for example, an image editing application. The user 112 can use the design application 114 to modify the UI design 116, such as to remove UI components from the UI design 116 to specify that such components should not be included in the new portal page. The user 112 can also customize the style of UI components in the UI design 116, such as by changing colors, component and/or elements sizes, relative location within the design, or other style attributes. In some instances, the default UI template 118 may be an interactive electronic form or document allowing user interaction and manipulation, allowing users to define a UI design 116 representing a modified default UI template 118.

The UI design 116 can be sent to the enterprise portal server 106 and an analysis module 122 included in an automatic theme generator 124 can analyze differences between the UI design 116 and the default UI template 120. For example, the analysis module 122 can identify style differences between the UI design 116 and the default UI template 120 (e.g., color, size, relative location, etc.), and can identify whether UI components included in the default UI template 120 are not included in the UI design 116.

A generator module 126 included in the automatic theme generator 124 can generate code and/or style elements for the new portal page based on the analyzed differences between the UI design 116 and the default UI template 120. The new portal page can be stored in a generated portal pages repository 128. The new portal page can be viewed, for example, by the desktop client 104a and other desktop clients using, for example, a browser 130. In some implementations, the new portal page is a modification of a default portal page (e.g., the generated code and style elements can be used to modify the default portal page). In some implementations, the generator module 126 stores a copy or a representation of the new portal page as a modified UI template in a modified UI templates repository 129, to enable future UI designs to be created as modifications of the modified UI template.

In some implementations, the generator module 126 can generate other portal pages based on the identified differences, such as a tablet portal page for presentation to the tablet client 104b and/or a mobile portal page for presentation to the mobile client 104c. The tablet portal page and the mobile portal page can be stored in the generated portal pages repository 128. Code and/or style elements for the tablet portal page and the mobile portal page can be generated based on the analyzed differences between the UI design 116 and the default UI template 120. For example, the generator module 126 can identify UI components in a default mobile portal page or a default tablet portal page that correspond to UI components in the default UI template (e.g., where the default UI template is a template for web pages presented to desktop clients such as the desktop client 104a). The generator module 126 can generate code and/or style elements for the identified UI components to implement changes in the default mobile portal page or default tablet portal page that reflect or correspond to the analyzed differences between the UI design 116 and the default UI template 120.

In some implementations, the UI design 116 and the default UI template 120 are associated with a portal page designed for presentation to the mobile device 104c or the tablet device 104b. In such implementations, the generator module 126 can generate code and/or style elements for a new portal page for presentation to the desktop client 104a based on analyzed differences between a mobile or tablet UI design and a mobile or tablet default UI template, respectively.

As used in the present disclosure, the term “computer” is intended to encompass any suitable processing device. For example, although FIG. 1 illustrates a single enterprise portal server 106, the environment 100 can be implemented using two or more enterprise portal servers 106, as well as computers other than servers, including a server pool. Indeed, the enterprise portal server 106 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the enterprise portal server 106 may be adapted to execute any operating system, including Linux, UNIX, Windows, Mac OS®, Java™, Android™, iOS or any other suitable operating system. According to one implementation, the enterprise portal server 106 may also include or be communicably coupled with an e-mail server, a Web server, a caching server, a streaming data server, and/or other suitable server.

The enterprise portal server 106 includes an interface, one or more processors, and a memory 134. The interface is used by the enterprise portal server 106 for communicating with other systems in a distributed environment—including within the environment 100—connected to the network 110; for example, the client devices 104a-c, as well as other systems communicably coupled to the network 110. Generally, the interface comprises logic encoded in software and/or hardware in a suitable combination and operable to communicate with the network 110. More specifically, the interface may comprise software supporting one or more communication protocols associated with communications such that the network 110 or interface's hardware is operable to communicate physical signals within and outside of the illustrated environment 100.

Each processor included in the enterprise portal server 106 may be a central processing unit (CPU), a blade, an application specific integrated circuit (ASIC), a field-programmable gate array (FPGA), or another suitable component. Generally, each processor included in the enterprise portal server 106 executes instructions and manipulates data to perform the operations of the enterprise portal server 106. Specifically, each processor included in the enterprise portal server 106 executes the functionality required to receive and respond to requests from the client devices 104a-c, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The enterprise portal server 106 includes the memory 134 (or, in some implementations, multiple memories). The memory 134 included in the enterprise portal server 106 may include any type of memory or database module and may take the form of volatile and/or non-volatile memory including, without limitation, magnetic media, optical media, random access memory (RAM), read-only memory (ROM), removable media, or any other suitable local or remote memory component. The memory 134 may store various objects or data, including UI designs, default UI templates, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the enterprise portal server 106.

The client devices 104a-c may generally be any computing device operable to connect to or communicate with at least the enterprise portal server 106 via the network 110 using a wireline or wireless connection. In general, the client devices 104a-c each comprise an electronic computer device operable to receive, transmit, process, and store any appropriate data associated with the environment 100 of FIG. 1. The client devices 104a-c can each include one or more client applications. A client application is any type of application that allows the client devices 104a-c to request and view content on the respective client device. In some implementations, a client application can use parameters, metadata, and other information received at launch to access a particular set of data from the enterprise portal server 106. In some instances, a client application may be an agent or client-side version of the one or more enterprise applications running on the enterprise portal server 106.

The client devices 104a-c each further include an interface, one or more processors, and a memory (e.g., a memory 136). Such an interface of a respective client device 104a-c can be for communicating with other systems in a distributed environment—including within the environment 100—connected to the network 110; for example, the enterprise portal server 106, as well as other systems communicably coupled to the network 110. Generally, the interface of a respective client device 104a-c comprises logic encoded in software and/or hardware in a suitable combination and operable to communicate with the network 110. More specifically, the interface of a respective client device 104a-c may comprise software supporting one or more communication protocols associated with communications such that the network 110 or interface's hardware is operable to communicate physical signals within and outside of the illustrated environment 100.

Each processor included in the client devices 104a-c may be a central processing unit (CPU), an application specific integrated circuit (ASIC), a field-programmable gate array (FPGA), or another suitable component. Generally, each processor included in the client devices 104a-c executes instructions and manipulates data to perform the operations of the respective client device. Specifically, each processor included in the client devices 104a-c executes the functionality required to send requests to the enterprise portal server 106 and to receive and process responses from the enterprise portal server 106.

The memory included in the client devices 104a-c (e.g., the memory 136) may include any memory or database module and may take the form of volatile or non-volatile memory including, without limitation, magnetic media, optical media, random access memory (RAM), read-only memory (ROM), removable media, or any other suitable local or remote memory component. The memory included in the client devices 104a-c may store various objects or data, including UI designs, default UI templates, user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the respective client device.

There may be any number of client devices associated with, or external to, the environment 100. For example, while the illustrated environment 100 includes three client devices, alternative implementations of the environment 100 may include any number of client devices communicably coupled to the enterprise portal server 106 and/or the network 110. Additionally, there may also be one or more additional client devices external to the illustrated portion of environment 100 that are capable of interacting with the environment 100 via the network 110. Further, the term “client”, “mobile device” and “user” may be used interchangeably as appropriate without departing from the scope of this disclosure. Moreover, while the client devices 104a-c are described in terms of being used by a single user, this disclosure contemplates that many users may use one computer, or that one user may use multiple computers.

The client devices 104a-c are generally intended to encompass any client computing device such as a laptop/notebook computer, wireless data port, smart phone, personal data assistant (PDA), tablet computing device, one or more processors within these devices, or any other suitable processing device. For example, some or all of the client devices 104a-c may comprise a computer that includes an input device, such as a keypad, touch screen, or other device that can accept user information, and an output device that conveys information associated with the operation of the enterprise portal server 106 or the respective client device itself, including digital data, visual information, or a graphical user interface.

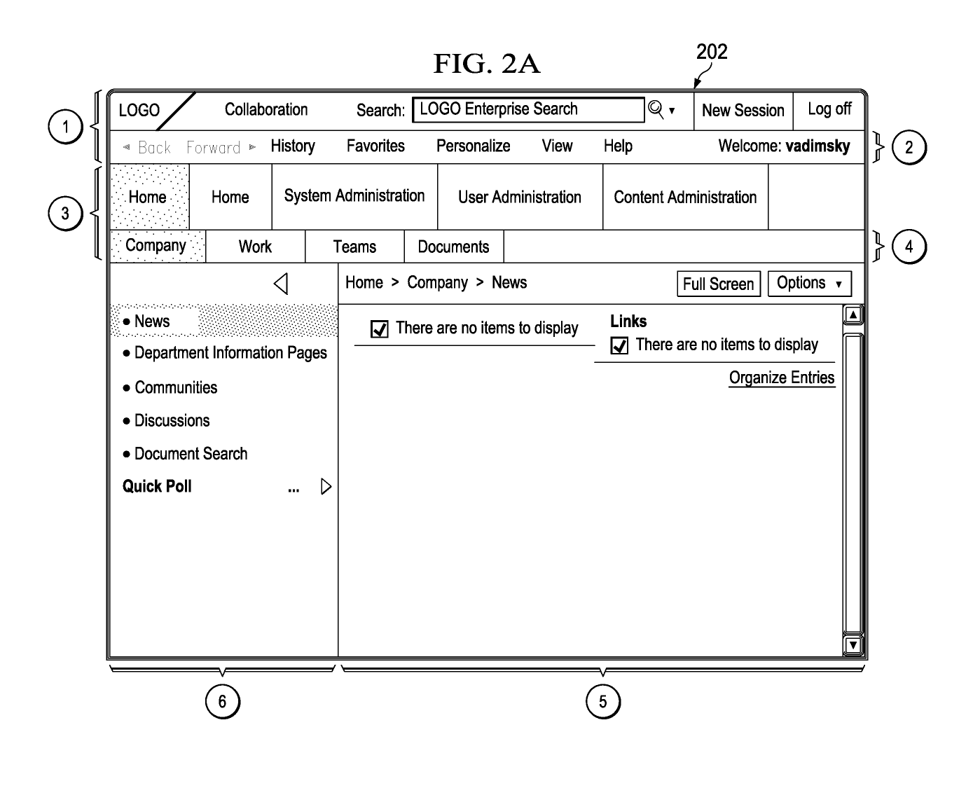

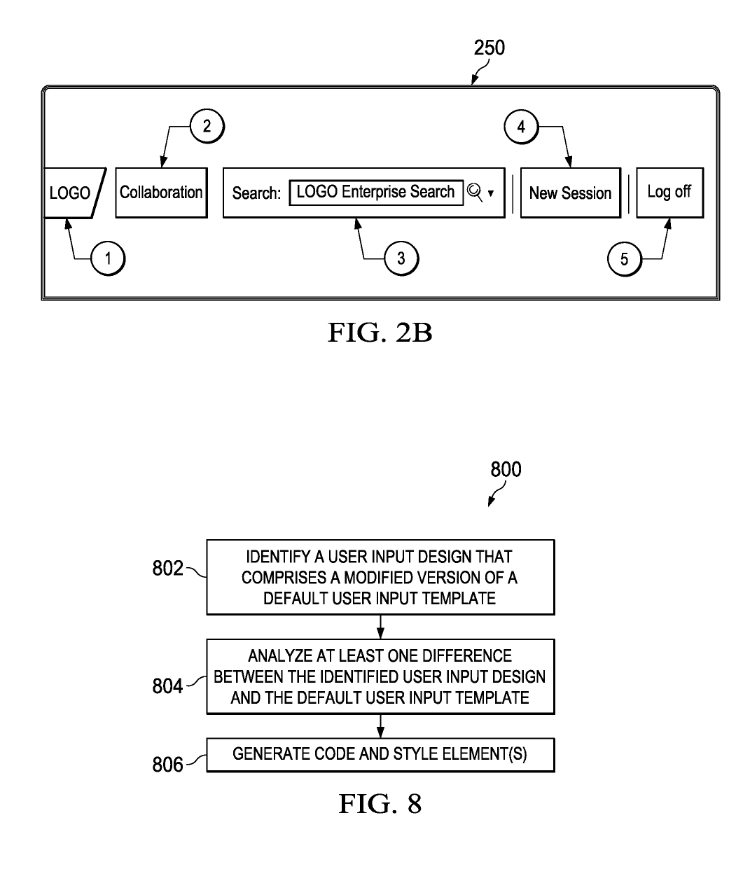

FIG. 2A illustrates an example portal page 202 that presents an example default UI template. The default UI template 202 include components common to user interfaces used in an organization. The example default UI template includes a set of UI components, numbered one to six. A masthead (e.g., component one) includes a set of UI components that provide access to features such as searching and session management. A masthead menu bar (e.g., component two) provides access to history, favorites, help, and other features. Other features can be accessed using a first level navigation menu (e.g., component three), a second level navigation menu (e.g., component four), and a navigation panel (e.g., component six). Selection of a component in a masthead, menu bar, or navigation panel can result in presentation of content in a content area (e.g., component five).

The default UI template defines a set of styles for the UI components included in the default UI template. For example, background and foreground colors can be defined for the navigation panel, the content area, and the menu bar areas. The default UI template can indicate relative placement and size of the UI components. For example, the default UI template can indicate that the navigation panel is to the left of the content area, and that the navigation panel and the content area occupy twenty percent and eighty percent of the width of the portal page 202, respectively.

FIG. 2B illustrates UI components that can be included in a masthead component 250 included in a default UI template. The masthead component 250 can include, for example, a logo (e.g., component one) and a search component (e.g., component three). As other examples, the masthead component 250 can include link controls (e.g., components two, four, and five) which provide access to various features (e.g., collaboration, start new session, and log off, respectively). Such features can be, for example, standard features that are generally included in user interfaces used in an organization.

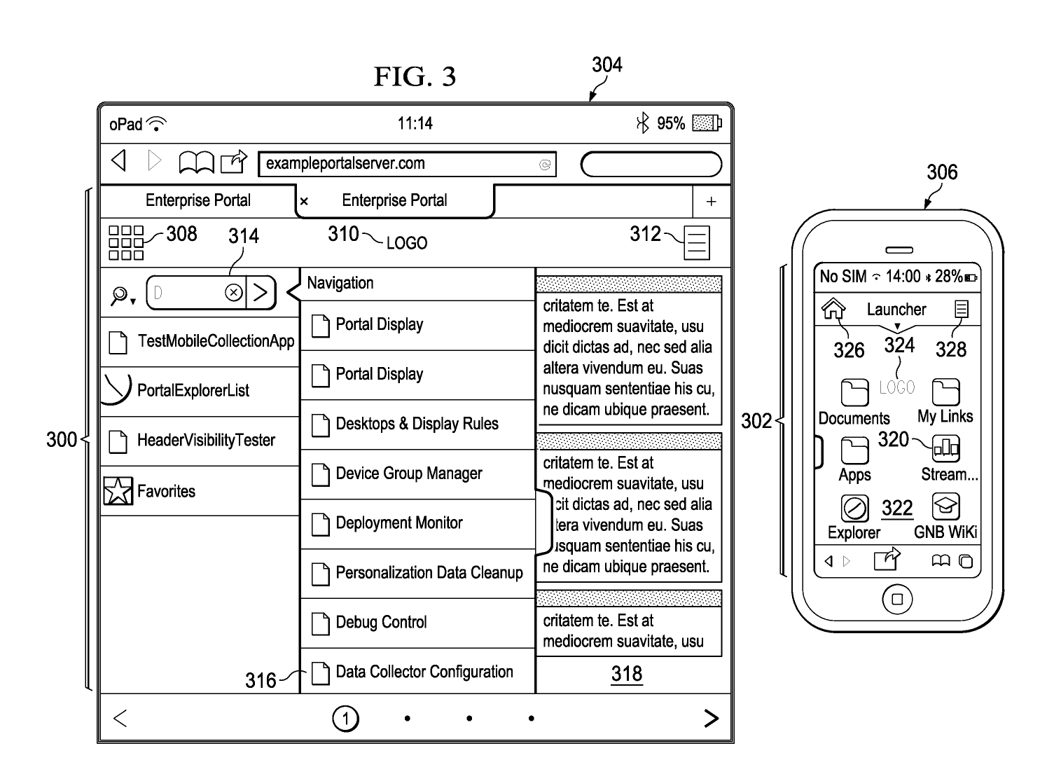

FIG. 3 illustrates example portal pages 300 and 302 that present an example default UI template on a tablet device 304 and on a mobile device 306, respectively. The default UI template presented in the portal page 300 illustrates default styles, branding, and UI components for presentation on tablet devices. For example, the default UI template presented in the portal page 300 includes a control menu 308, a logo 310, a control menu 312, a search control 314, a menu control 316, and a content area 318. Each of the UI components 308-318 included in the portal page 300 are presented with default styles, such as default colors and fonts. Similarly, the default UI template presented in the portal page 302 illustrates default styles, branding, and UI components for presentation on mobile devices. For example, the default UI template presented in the portal page 302 includes an icon 320, among other icons, defines a background color for a content area 322, includes a logo 324, which may be a background image for the content area 322, includes a home icon 326, and a control menu 328.

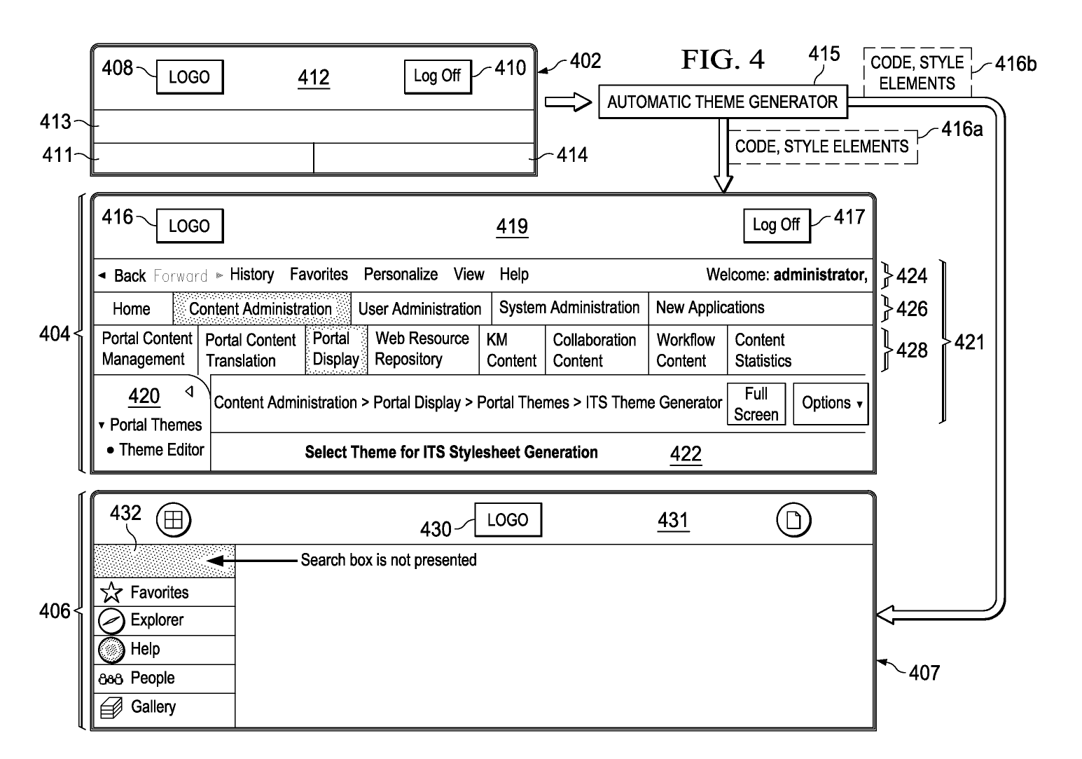

FIG. 4 illustrates a first example of a UI design 402 and corresponding generated web pages 404 and 406. The web pages 404 and 406 include code and style elements generated based on analyzed differences between the UI design 402 and a default UI template. The web page 404 is for presentation on a desktop client and the web page 406 is for presentation on a tablet device 407. A web page for presentation on a mobile device (not shown) can also be generated.

The UI design 402 includes a logo 408 and a logoff control 410. The UI design 402 does not include several UI components that are included in the example masthead component 240 described above with respect to FIG. 2B (e.g., the UI design 402 does not include a search control, or start new session or collaboration links). The UI design 402 can include style definitions for one or more UI components. For example, the UI design 402 can include definitions for a background color for the logo 408, the logoff control 410, a navigation panel 411, a masthead 412, a navigation menu 413, and a content area 414.

An automatic theme generator 415 can compare the UI design 402 with a default UI template (e.g., the default UI template presented in the portal page 202) and can analyze differences between the UI design 402 and the default UI template. The automatic theme generator 415 can generate code and one or more style elements for the web page 404 and the web page 406 (e.g., code/style elements 416a and 416b, respectively), based on the analyzed differences between the UI design 402 and the default UI template. For example, the automatic theme generator 415 can generate code and/or style elements for a logo 416, a logoff control 417, a masthead 419, a navigation panel 420, a navigation menu 421, and a content area 422, where the generated style elements for the UI components 416-422 are generated based at least in part on style information for the logo 408, the logoff control 410, the masthead 412, the navigation panel 411, the navigation menu 413, and the content area 414, respectively.

The automatic theme generator 415 can generate a portion of the web page 404 based on a default set of code and style elements that are unaffected by the analyzed differences between the UI design 402 and the default UI template. Default code and style information can be included in or otherwise associated with the default UI template, for each UI component included in the default UI template. For example, the automatic theme generator 415 can use the default set of code and style elements to generate portions of the web page 404 that include a menu bar 424, a first level navigation menu 426, and a second level navigation menu 428.

In some implementations, the automatic theme generator 415 can remove, from a default set of code, code that is associated with a UI component that is included in the default UI template but is not included in the UI design. For example, default code that is included in or otherwise associated with the default UI template can include code for a search control (e.g., the search control included in the default UI template presented in the portal page 202). The automatic theme generator 415 can generate code for the web page 402 without including such search control code, since the UI design 402 does not include a search control.

The automatic theme generator 415 can also generate code and/or one or more style elements for the web page 406. For example, code and/or style elements for a logo 430 can be generated, based on information associated with the logo 408. As another example, one or more style elements can be generated for a header 431, based on style information included in the UI design 402. For example, the automatic theme generator 415 can identify a color for the header 431 based on color information included in the UI design 402, such as by identifying a color used in the UI design 402 or a color that complements one or more colors used in the UI design 402.

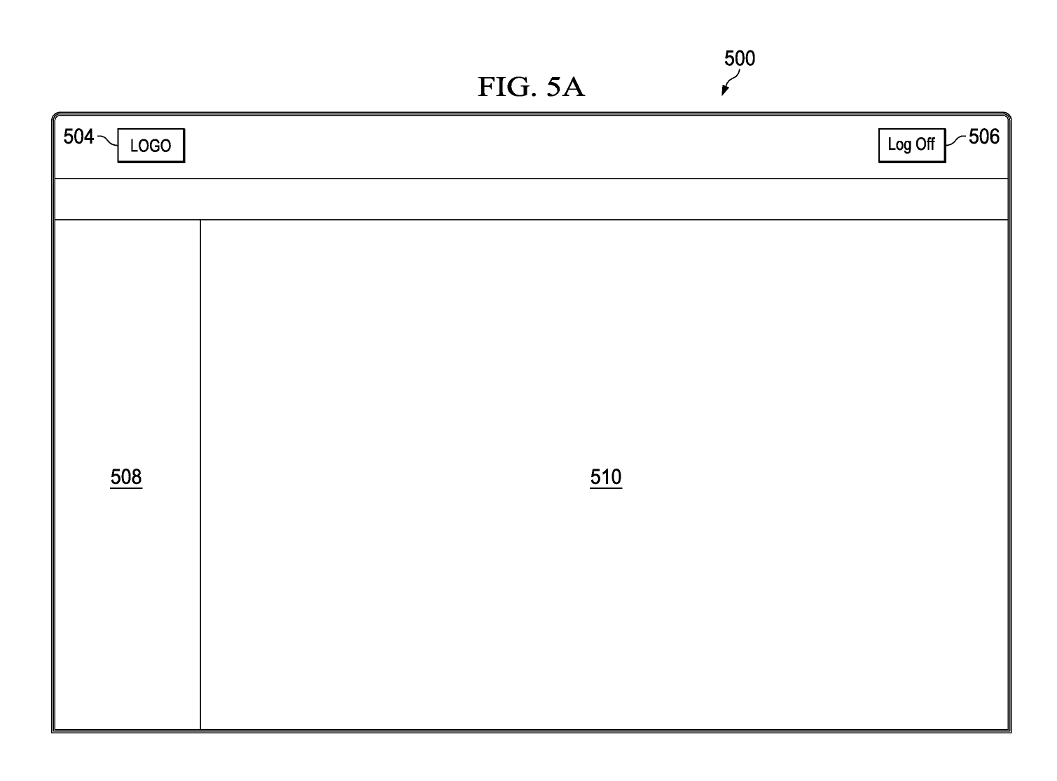

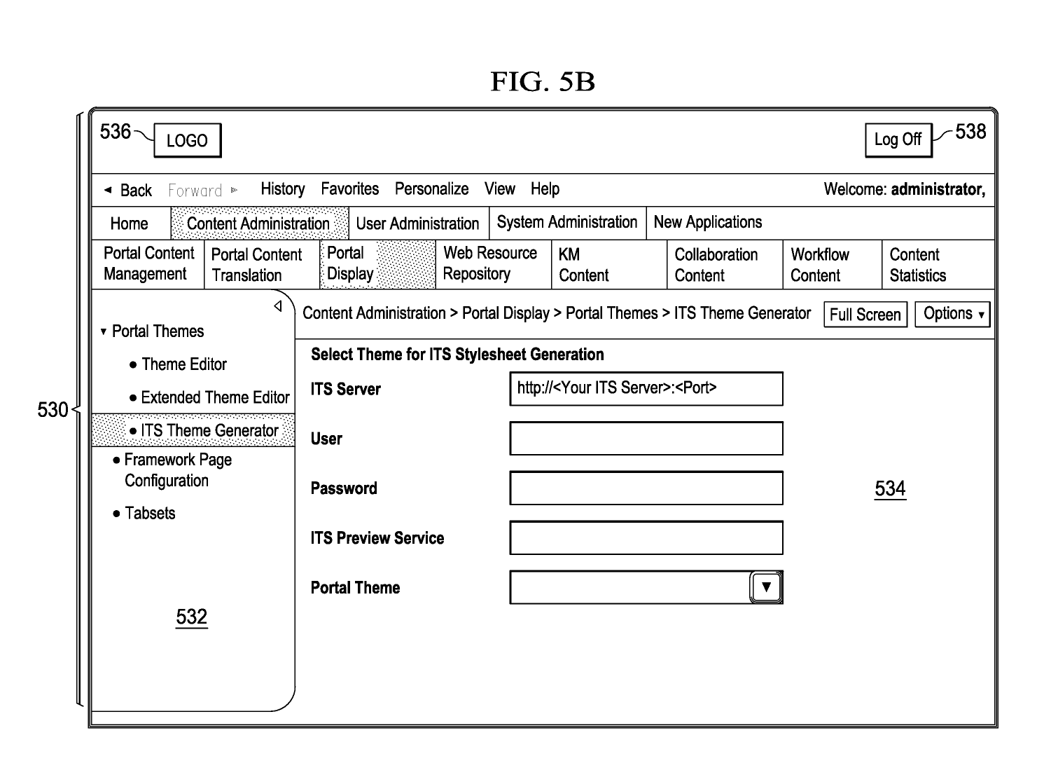

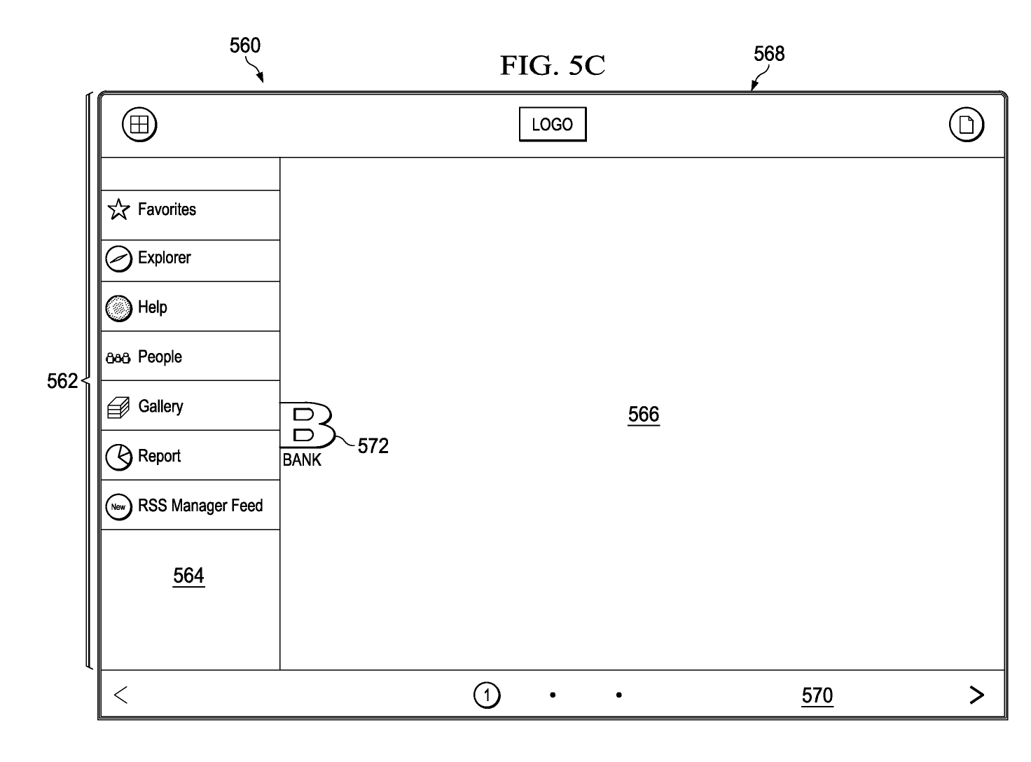

FIGS. 5A to 5C illustrate a second example UI design and corresponding generated web pages. Similar to the UI design 402, a UI design 500 illustrated in FIG. 5A includes a logo 504 and a logoff control 506, and defines a first color for a navigation panel 508 and a second color for a content area 510. In addition to including UI components and style definitions, the UI design 500 can indicate relative sizing of UI components. For example, the UI design 500 can indicate relative widths of the navigation panel 508 and the content area 510, as compared to the overall width of the UI design 500. For example, the user can specify, in the UI design, a width of the navigation panel 508 that is different than the width of the corresponding “component six” navigation panel in the default UI template presented in the portal page 202 (e.g., described above with respect to FIG. 2A). For example, the navigation panel 508 can be wider than the width of the navigation panel included in the default UI template (and, correspondingly, the width of the content area 510 may be more narrow than the width of the content area included in the default UI template).

FIG. 5B illustrates a web page 530 that is generated by an automatic theme generator (e.g., the automatic theme generator 415) based on analyzing differences between the UI design 500 and a default UI template. The relative width of components in the web page 530 correspond to relative widths of corresponding components in the UI design 500. For example, the ratio of the width of a navigation panel 532 to the width of a content area 534 corresponds to the ratio of the width of the navigation panel 508 to the width of the content area 510. Other aspects of the web page 530 correspond to the UI design 500, such as the color of the navigation panel 532, the color of the content area 534, and the placement of a logo 536 and a logoff control 538.

FIG. 5C illustrates a tablet device 560 which presents a web page 562 generated by an automatic theme generator (e.g., the automatic theme generator 415) based on analyzing differences between the UI design 500 and a default UI template. The ratio of the width of a navigation panel 564 to the width of a content area 566 corresponds to the ratio of the width of the navigation panel 508 to the width of the content area 510. Other aspects of the web page 562 correspond to the UI design 500, such as the color of a header 568 and the color of a footer 570 corresponding to one or more colors in the UI design 500 and a logo 572 corresponding to the logo 504.

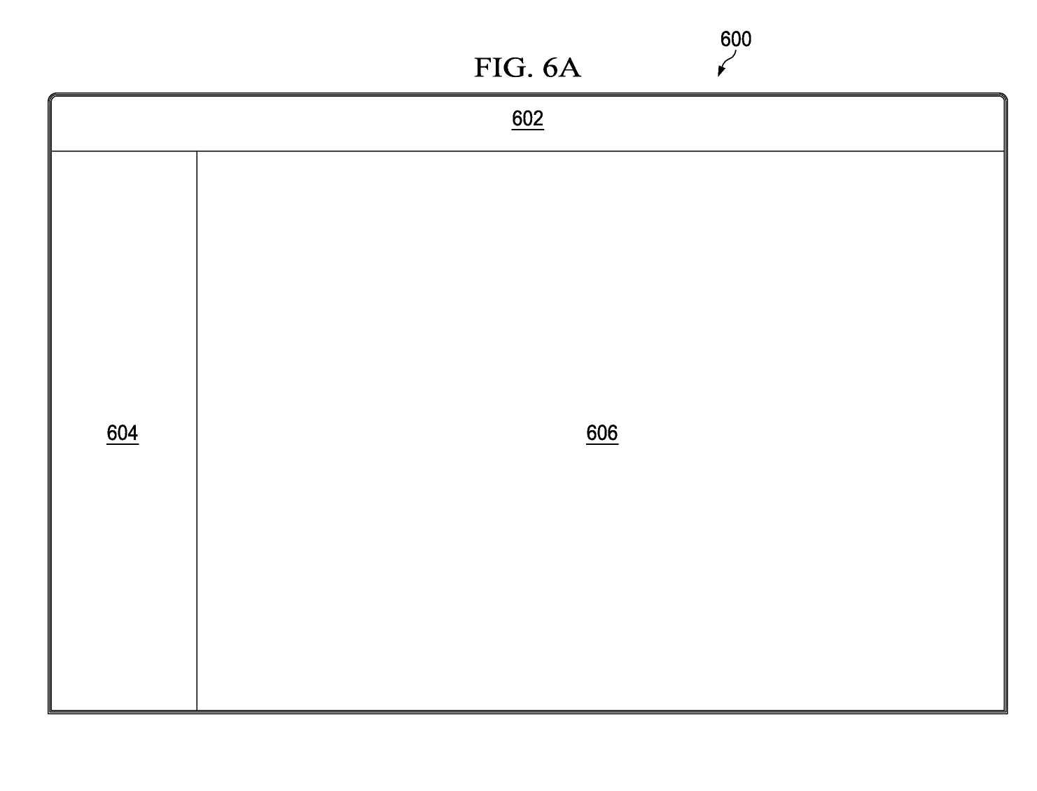

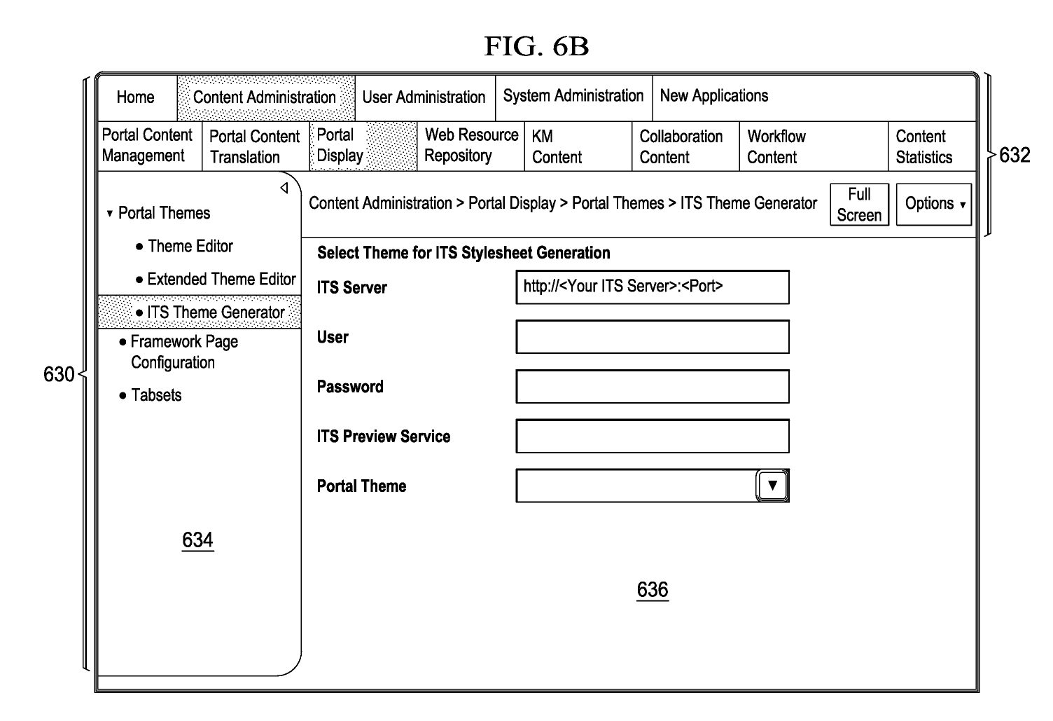

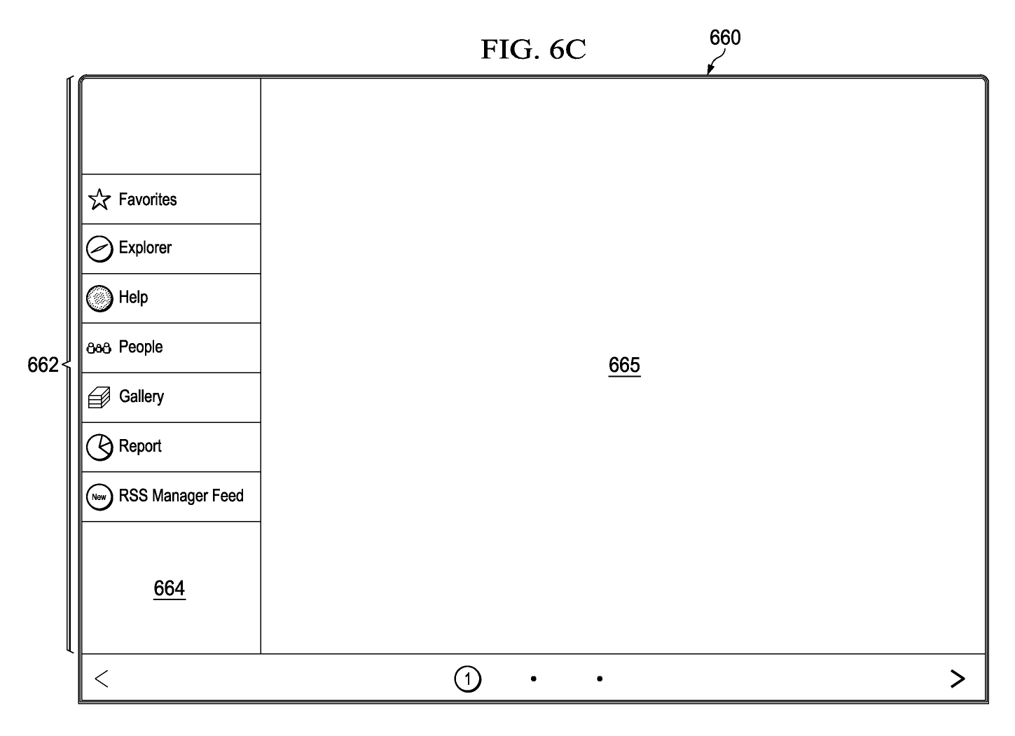

FIGS. 6A to 6C illustrate a third example UI design and corresponding generated web pages. As illustrated in FIG. 6A, a UI design 600 includes a navigation menu 602, a navigation panel 604, and a content area 606. The UI design 600 does not include a masthead area (e.g., the UI design 402 described above with respect to FIG. 4 includes a masthead 412 and a navigation menu 413, whereas the UI design 600 includes the navigation menu 602 but not a masthead).

FIG. 6B illustrates a web page 630 that is generated by an automatic theme generator (e.g., the automatic theme generator 415) based on analyzing differences between the UI design 600 and a default UI template. The web page 630 includes a navigation menu 632, a navigation panel 634, and a content area 636, corresponding to the navigation menu 602, the navigation panel 604, and the content area 606, respectively. In accordance with the UI design 600, the web page 630 does not include a masthead.

FIG. 6C illustrates a tablet device 660 which presents a web page 662 generated by an automatic theme generator (e.g., the automatic theme generator 415) based on analyzing differences between the UI design 600 and a default UI template. The web page 662 includes a navigation panel 664 and a content area 665 corresponding to the navigation panel 604 and the content area 606, respectively. In accordance with the UI design 600, the web page 662 does not include a masthead.

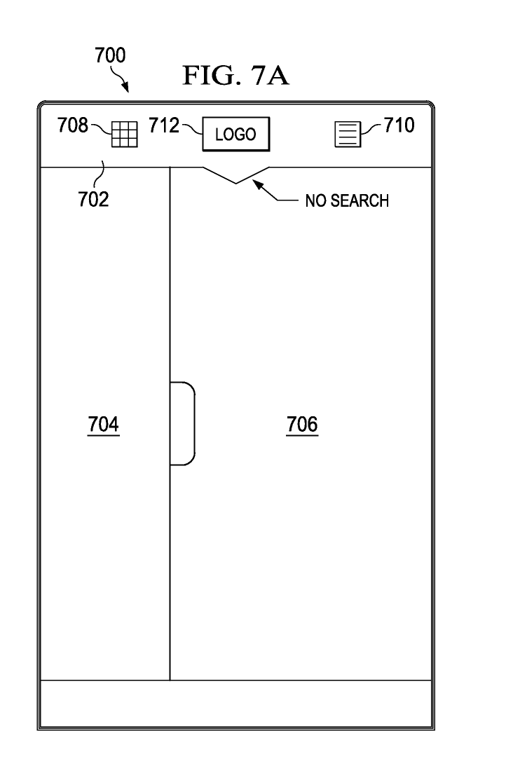

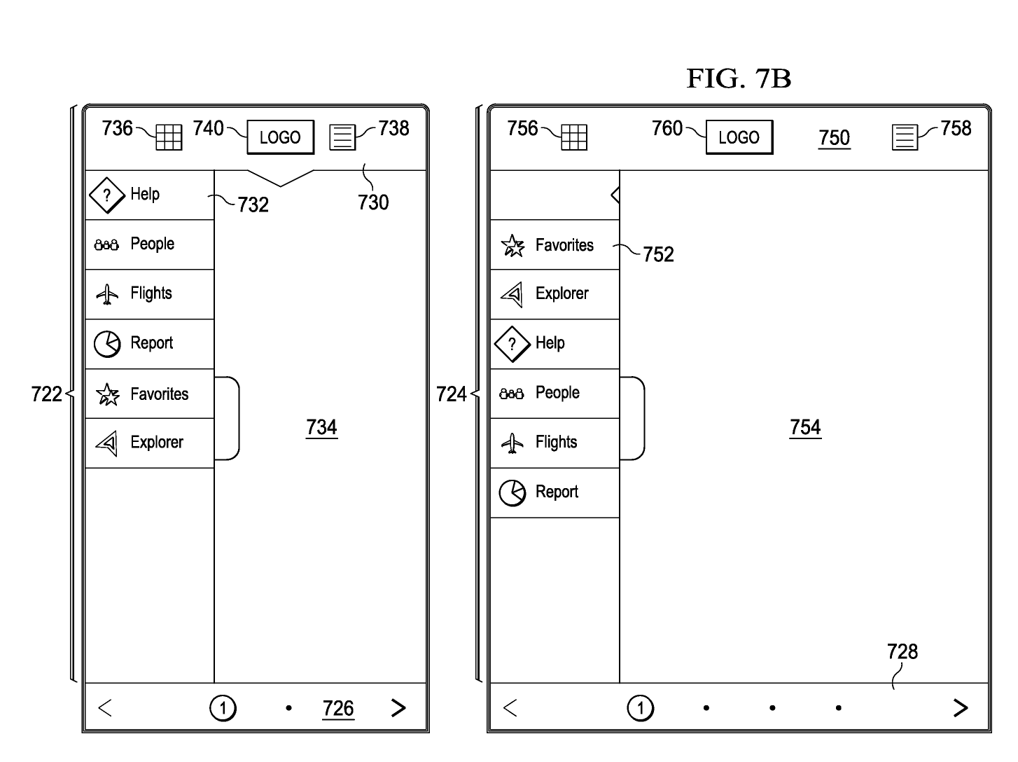

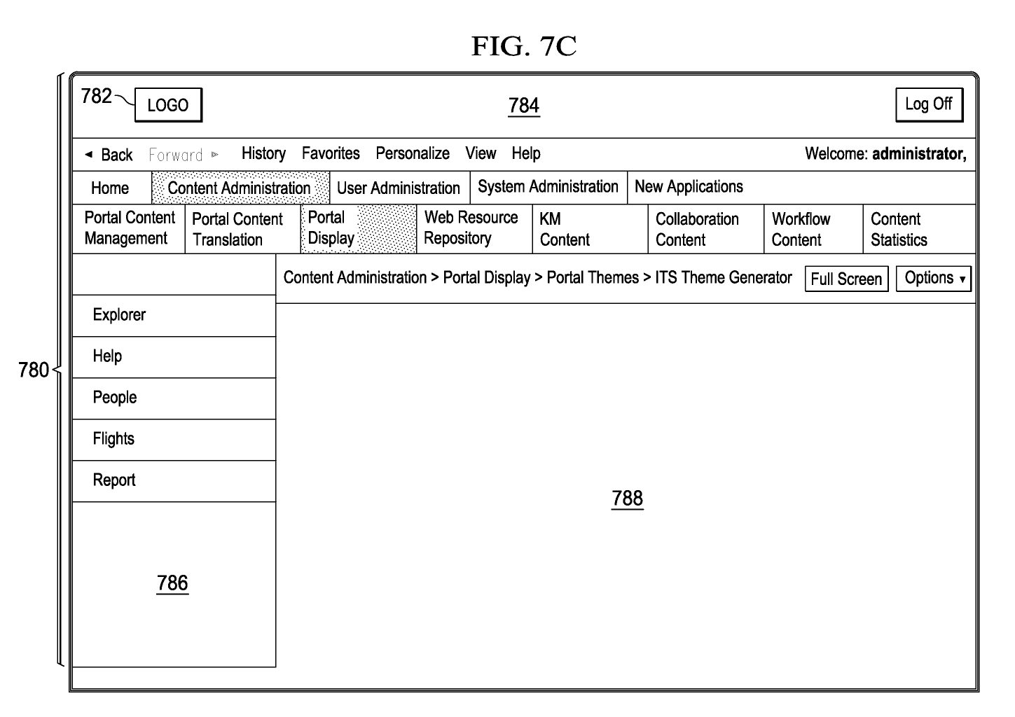

FIGS. 7A-7C illustrate a UI design for generation of portal pages for presentation to clients via a mobile device or a tablet device and corresponding generated web pages. FIG. 7A illustrates a UI design 700 for generation of portal pages for presentation to clients via a mobile device or a tablet device. The UI design 700 includes a masthead 702, a navigation panel 704, and a content area 706. The masthead 702 includes controls 708 and 710 and a logo 712.

FIG. 7B illustrates web pages 722 and 724 presented on a mobile device 726 and a tablet device 728, respectively. The web pages 722 and 724 are generated by an automatic theme generator (e.g., the automatic theme generator 415) based on analyzing differences between the UI design 700 and a default UI template associated with a portal page for presentation to clients via a mobile device, such as the default UI template presented in the portal page 302 (e.g., a “mobile default UI template”). In accordance with the UI design 700, the web page 722 includes a masthead 730, a navigation panel 732, a content area 734, controls 736 and 738, and a logo 740, corresponding to the masthead 702, the navigation panel 704, the content area 706, the controls 708 and 710, and the logo 712, respectively. Similarly, the web page 724 includes a masthead 750, a navigation panel 752, a content area 754, controls 756 and 758, and a logo 760, corresponding to the masthead 702, the navigation panel 704, the content area 706, the controls 708 and 710, and the logo 712, respectively.

FIG. 7C illustrates a web page 780 presented to a desktop client. The web page 780 can be generated by an automatic theme generator (e.g., the automatic theme generator 415) based on analyzed differences between the UI design 700 and a mobile default UI template. For example, the automatic theme generator can generate code and/or style elements for a logo 782, a masthead 784, a navigation panel 786, and a content area 788. The background color of the navigation panel 786 can correspond, for example, to the background color of the navigation panel 704. As another example, the foreground and background colors of the content area 788 can correspond to the foreground and background colors of the content area 706, respectively. As yet another example, style elements generated for the logo 782 and masthead 784 can correspond to style information for the logo 712 and the masthead 702, respectively.

FIG. 8 is a flowchart of an example method 800 for generating code and/or style elements for a web page based on analyzed differences between a UI design and a default UI template. For clarity of presentation, the description that follows generally describes method 800 and related methods in the context of FIG. 1. However, it will be understood that method 800 and related methods may be performed, for example, by any other suitable system, environment, software, and hardware, or a combination of systems, environments, software, and hardware, as appropriate. For example, one or more of the enterprise portal server, a client, or other computing device (not illustrated) can be used to execute method 800 and related methods and obtain any data from the memory of a client, the enterprise portal server, or the other computing device (not illustrated).

At 802, a UI design created for at least one web page is identified. The UI design can be, for example, a modified version of a default UI template. In some implementations, the identified UI design and the default UI template are associated with a portal page for presentation to desktop clients. In such implementations, the UI design and the default UI template can be referred to as a desktop UI design and a desktop default UI template, respectively. In such implementations, the desktop default UI template can be further associated with one or more other default UI templates, such as a mobile default UI template for a portal page for presentation to clients via a mobile device and/or a tablet default UI template for a portal page for presentation to clients via a tablet device. In some implementations, the identified UI design is a mobile UI design or tablet UI design, which is a modified version of a mobile default UI template, or a tablet default UI template, respectively.

The identified UI design and the default UI template can each include a set of UI components and styles. Generally, at least one UI component or style in the identified UI design is different than a corresponding UI component or style in the default UI template. The UI design can be or can include, for example, an image. A component in the UI design can be represented, for example, by an area of the image. Each area can include or can be associated with style information, including, but not limited to, colors, sizes of components and elements, relative locations of components and elements, as well as other style-related information. Each area of the UI design can correspond to a UI component included in the default UI template.

At 804, at least one difference between the identified UI design and the default UI template is analyzed. For example, a difference in style information between an area of the UI design and a corresponding UI component of the default UI template can be determined. For example, a background color of an area in the UI design may differ from the background color of a corresponding UI component in the default UI template.

Areas of the UI design can be mapped to or associated with corresponding UI components in the default UI template by detecting the presence or absence of an area in the UI design based on an expected area configuration, where the expected area configuration corresponds to the number, placement, and relative size of UI components in the default UI template. For example, the default UI template may include the following UI components, listed in order as if traversing the UI components starting from the upper left of the default UI template and traversing leftward and downward through the UI components of the default UI template: a masthead, a masthead menu bar, a first level navigation menu, a second level navigation menu, a navigation panel, and a content area.

A determination can be made as to whether the UI design includes an area for each of the UI components in the default UI template. If the UI design includes an area for each of the UI components in the default UI template, a determination can be made that the UI design does not specify removal of any UI components. If the UI design does not include an area for each of the UI components in the default UI template, the areas that are not in the UI design and the corresponding UI components in the default UI template can be identified. For example, a determination can be made that the UI design does not include an area that corresponds to a masthead menu (e.g., which indicates that the UI design is specifying the removal of the masthead menu). As another example, a determination can be made that the UI design does not include an area that corresponds to a search control that is included in the default UI template (e.g., which indicates that the UI design is specifying the removal of the search control).

Other analyzed differences between the UI design and the default UI template can be identified. For example, difference in font characteristics, borders, padding, or size can be identified. Other style differences may be identified. Other approaches may be used for identifying items in the UI design or comparing the UI design to the default UI template. For example, OCR (Optical Character Recognition) can be used to identify component-relevant text (e.g., “Menu”) in the UI design, and such text can be matched to corresponding components in the default UI template. Other image processing techniques can be used, such as to identify the presence of components in the UI design.

At 806, at least a subset of code and at least one style element is generated for the at least one web page in response to identifying the UI design, where the subset of generated code and the at least one generated style element are based on the at least one analyzed difference between the identified UI design and the default UI template. In some implementations, if the UI design is a desktop UI design, the web page may be associated with a portal page for presentation to desktop clients. That is, code and style elements for a web page associated with a portal page for presentation to desktop clients may be generated based on differences between a desktop UI design and a desktop UI template. In other implementations, code and style elements for a web page associated with a portal page for presentation to mobile or tablet clients may be generated based on differences between a desktop UI design and a desktop UI template. In still other implementations, code and style elements for a web page associated with a portal page for presentation to desktop clients may be generated based on differences between a mobile or tablet UI design and a mobile or tablet default UI template.

The preceding figures and accompanying description illustrate example processes and computer-implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method comprising:
identifying a user interface (UI) design created for at least one web page, where the UI design comprises a modified version of a default UI template;
analyzing at least one difference between the identified UI design and the default UI template; and
generating at least a subset of code and at least one style element for the at least one web page in response to identifying the UI design, the subset of generated code and the at least one generated style element based on the at least one analyzed difference between the identified UI design and the default UI template.

2. The method of claim 1, wherein the identified UI design and the default UI template are associated with a portal page for presentation to desktop clients.

3. The method of claim 2, wherein the default UI template is further associated with at least one default UI template for a portal page for presentation to clients via a mobile device or a tablet device.

4. The method of claim 3, further comprising generating at least a subset of code and at least one style element for at least one web page associated with a portal page for presentation to clients via the mobile device or the tablet device based on the at least one analyzed difference between the identified UI design and the default UI template associated with the portal page for presentation to desktop clients.

5. The method of claim 4, wherein the subset of generated code and the at least one generated style element associated with the portal page for presentation to clients via the mobile device or the tablet device are used to modify a default portal page for presentation to clients via the mobile device or the tablet device, and where the portal page for presentation to clients via the mobile device or the tablet device is different from the portal page for presentation to desktop clients.

6. The method of claim 1, wherein the identified UI design and the default UI template each include a set of UI components and styles.

7. The method of claim 6, wherein at least one UI component or style in the identified UI design is different than a corresponding at least one UI component or style in the default UI template.

8. The method of claim 1, wherein the identified UI design and the default UI template are associated with a portal page for presentation to clients via a mobile device or a tablet device.

9. The method of claim 8, further comprising generating at least a subset of code and at least one style element for at least one web page associated with a portal page for presentation to desktop clients based on the at least one analyzed difference between the identified UI design and the default UI template associated with the portal page for presentation to clients via the mobile device or the tablet device.

10. The method of claim 1, wherein generating at least a subset of code and at least one style element for the at least one web page in response to identifying the UI design further includes:
generating a portion of the at least one web page based on the subset of generated code and at least one generated style element; and
generating a portion of the at least one web page based on a default set of code and style elements unaffected by the at least one difference between the identified UI design and the default UI template.

11. The method of claim 1, wherein the identified UI design and the default UI template are static images.

12. A system comprising:
one or more computers associated with an enterprise portal; and
a computer-readable medium coupled to the one or more computers having instructions stored thereon which, when executed by the one or more computers, cause the one or more computers to perform operations comprising:
identifying a user interface (UI) design created for at least one web page, where the UI design comprises a modified version of a default UI template;
analyzing at least one difference between the identified UI design and the default UI template; and
generating at least a subset of code and at least one style element for the at least one web page in response to identifying the UI design, the subset of generated code and the at least one generated style element based on the at least one analyzed difference between the identified UI design and the default UI template.

13. The system of claim 12, wherein the identified UI design and the default UI template are associated with a portal page for presentation to clients via a mobile device or a tablet device.

14. The system of claim 13, the operations further comprising generating at least a subset of code and at least one style element for at least one web page associated with a portal page for presentation to desktop clients based on the at least one analyzed difference between the identified UI design and the default UI template associated with the portal page for presentation to clients via the mobile device or the tablet device.

15. The system of claim 12, wherein the identified UI design and the default UI template are static images.

16. A computer program product encoded on a non-transitory storage medium, the product comprising non-transitory, computer readable instructions for causing one or more processors to perform operations comprising:
identifying a user interface (UI) design created for at least one web page, where the UI design comprises a modified version of a default UI template;
analyzing at least one difference between the identified UI design and the default UI template; and
generating at least a subset of code and at least one style element for the at least one web page in response to identifying the UI design, the subset of generated code and the at least one generated style element based on the at least one analyzed difference between the identified UI design and the default UI template.

17. The product of claim 16, wherein the identified UI design and the default UI template are associated with a portal page for presentation to clients via a mobile device or a tablet device.

18. The product of claim 17, the operations further comprising generating at least a subset of code and at least one style element for at least one web page associated with a portal page for presentation to desktop clients based on the at least one analyzed difference between the identified UI design and the default UI template associated with the portal page for presentation to clients via the mobile device or the tablet device.

19. The product of claim 16, wherein the identified UI design and the default UI template are static images.

20. A method comprising:
identifying a user interface (UI) design created for one or more web pages in a first set of web pages, where the UI design comprises a modified version of a default UI template, the identified UI design and the default UI template are static images, and the identified UI design and the default UI template are associated with a portal page for presentation to desktop clients;
analyzing at least one difference between the identified UI design and the default UI template;
generating at least a first subset of code and at least one first style element for one or more web pages in the first set of web pages in response to identifying the UI design, the first subset of generated code and the at least one generated first style element based on the at least one analyzed difference between the identified UI design and the default UI template; and
generating at least a second subset of code and at least one second style element for one or more web pages in a second set of web pages associated with a portal page for presentation to clients via a mobile device or a tablet device based on the at least one analyzed difference between the identified UI design and the default UI template associated with the portal page for presentation to desktop clients.
